(19) United States
(12) Patent Application Publication
(10) Pub. No.: US 2015/0326711 A1
(43) Pub. Date: Nov. 12, 2015

(54) CONNECTING TO A RETURN CALL

(71) Applicant: LENOVO (Singapore) PTE, LTD., New Tech Park (SG)

(72) Inventors: Nathan J. Peterson, Durham, NC (US); John Carl Mese, Cary, NC (US); Russell Speight VanBlon, Raleigh, NC (US); Rod D. Waltermann, Rougemont, NC (US); Arnold S. Weksler, Raleigh, NC (US)

(73) Assignee: LENOVO (Singapore) PTE, LTD., New Tech Park (SG)

(21) Appl. No.: 14/274,339

(22) Filed: May 9, 2014

(51) Int. Cl. H04M 3/424; H04M 3/533

(52) U.S. Cl. CPC H04M 3/424; H04M 3/533

(57) ABSTRACT

For connecting to a return call, a calling electronic device identifies a return call from a called number during communication with a voice messaging system associated with the called number. In addition, the calling electronic device connects to the return call.

### FIELD

The subject matter disclosed herein relates to connecting to a call and more particularly relates to connecting to a return call.

### BACKGROUND

1. Description of the Related Art

When leaving a message on a voice messaging system, an electronic device often receives a return call from the called number.

### BRIEF SUMMARY

An apparatus for connecting to a return call is disclosed. The apparatus includes an electronic device with the processor and memory that stores code executable by the processor. The code identifies a return call from a called number during communication with a voice messaging system associated with the called number. In addition, the code connects to the return call. A method and computer program product also perform the functions of the apparatus.

### BRIEF DESCRIPTION OF THE DRAWINGS

A more particular description of the embodiments briefly described above will be rendered by reference to specific embodiments that are illustrated in the appended drawings. Understanding that these drawings depict only some embodiments and are not therefore to be considered to be limiting of scope, the embodiments will be described and explained with additional specificity and detail through the use of the accompanying drawings, in which:

FIG. 1 is a schematic block diagram illustrating one embodiment of a return call system;

FIG. 2 is a schematic block diagram illustrating one embodiment of electronic device data;

FIG. 3 is a schematic block diagram illustrating one embodiment of voice messaging system data;

FIG. 4 is a schematic block diagram illustrating one embodiment of a computer;

FIG. 5A is a schematic flow chart diagram illustrating one embodiment of a return call connection method;

FIG. 5B is a schematic flow chart diagram illustrating one embodiment of a voice messaging system termination method;

FIG. 5C is a schematic flow chart diagram illustrating one alternate embodiment of a voice messaging system termination method;

FIG. 5D is a schematic flow chart diagram illustrating one alternate embodiment of a voice messaging system termination method;

FIG. 6A is a drawing illustrating one embodiment of a connection option and a connection confirmation; and

FIG. 6B is a drawing illustrating one embodiment of an erase option and an erase confirmation.

### DETAILED DESCRIPTION

As will be appreciated by one skilled in the art, aspects of the embodiments may be embodied as a system, method or program product. Accordingly, embodiments may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, embodiments may take the form of a program product embodied in one or more computer readable storage devices storing machine readable code, computer readable code, and/or program code, referred hereafter as code. The storage devices may be tangible, non-transitory, and/or non-transmission. The storage devices may not embody signals. In a certain embodiment, the storage devices only employ signals for accessing code.

Many of the functional units described in this specification have been labeled as modules, in order to more particularly emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in code and/or software for execution by various types of processors. An identified module of code may, for instance, comprise one or more physical or logical blocks of executable code which may, for instance, be organized as an object, procedure, or function. Nevertheless, the executables of an identified module need not be physically located together, but may comprise disparate instructions stored in different locations which, when joined logically together, comprise the module and achieve the stated purpose for the module.

Indeed, a module of code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different computer readable storage devices. Where a module or portions of a module are implemented in software, the software portions are stored on one or more computer readable storage devices.

Any combination of one or more computer readable medium may be utilized. The computer readable medium may be a computer readable storage medium. The computer readable storage medium may be a storage device storing the code. The storage device may be, for example, but not limited to, an electronic, magnetic, optical, electromagnetic, infrared, holographic, micromechanical, or semiconductor system, apparatus, or device, or any suitable combination of the foregoing.

More specific examples (a non-exhaustive list) of the storage device would include the following: an electrical connection having one or more wires, a portable computer diskette, a hard disk, a random access memory (RAM), a read-only memory (ROM), an erasable programmable read-only memory (EPROM or Flash memory), a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Code for carrying out operations for embodiments may be written in any combination of one or more programming languages, including an object oriented programming language such as Java, Smalltalk, C++ or the like and conventional procedural programming languages, such as the “C” programming language or similar programming languages. The code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Reference throughout this specification to “one embodiment,” “an embodiment,” or similar language means that a particular feature, structure, or characteristic described in connection with the embodiment is included in at least one embodiment. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to,” unless expressly specified otherwise. An enumerated listing of items does not imply that any or all of the items are mutually exclusive, unless expressly specified otherwise. The terms “a,” “an,” and “the” also refer to “one or more” unless expressly specified otherwise.

Furthermore, the described features, structures, or characteristics of the embodiments may be combined in any suitable manner. In the following description, numerous specific details are provided, such as examples of programming, software modules, user selections, network transactions, database queries, database structures, hardware modules, hardware circuits, hardware chips, etc., to provide a thorough understanding of embodiments. One skilled in the relevant art will recognize, however, that embodiments may be practiced without one or more of the specific details, or with other methods, components, materials, and so forth. In other instances, well-known structures, materials, or operations are not shown or described in detail to avoid obscuring aspects of an embodiment.

Aspects of the embodiments are described below with reference to schematic flowchart diagrams and/or schematic block diagrams of methods, apparatuses, systems, and program products according to embodiments. It will be understood that each block of the schematic flowchart diagrams and/or schematic block diagrams, and combinations of blocks in the schematic flowchart diagrams and/or schematic block diagrams, can be implemented by code. These code may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the schematic flowchart diagrams and/or schematic block diagrams block or blocks.

The code may also be stored in a storage device that can direct a computer, other programmable data processing apparatus, or other devices to function in a particular manner, such that the instructions stored in the storage device produce an article of manufacture including instructions which implement the function/act specified in the schematic flowchart diagrams and/or schematic block diagrams block or blocks.

The code may also be loaded onto a computer, other programmable data processing apparatus, or other devices to cause a series of operational steps to be performed on the computer, other programmable apparatus or other devices to produce a computer implemented process such that the code which execute on the computer or other programmable apparatus provide processes for implementing the functions/acts specified in the flowchart and/or block diagram block or blocks.

The schematic flowchart diagrams and/or schematic block diagrams in the Figures illustrate the architecture, functionality, and operation of possible implementations of apparatuses, systems, methods and program products according to various embodiments. In this regard, each block in the schematic flowchart diagrams and/or schematic block diagrams may represent a module, segment, or portion of code, which comprises one or more executable instructions of the code for implementing the specified logical function(s).

It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated Figures.

Although various arrow types and line types may be employed in the flowchart and/or block diagrams, they are understood not to limit the scope of the corresponding embodiments. Indeed, some arrows or other connectors may be used to indicate only the logical flow of the depicted embodiment. For instance, an arrow may indicate a waiting or monitoring period of unspecified duration between enumerated steps of the depicted embodiment. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and code.

The description of elements in each figure may refer to elements of proceeding figures. Like numbers refer to like elements in all figures, including alternate embodiments of like elements.

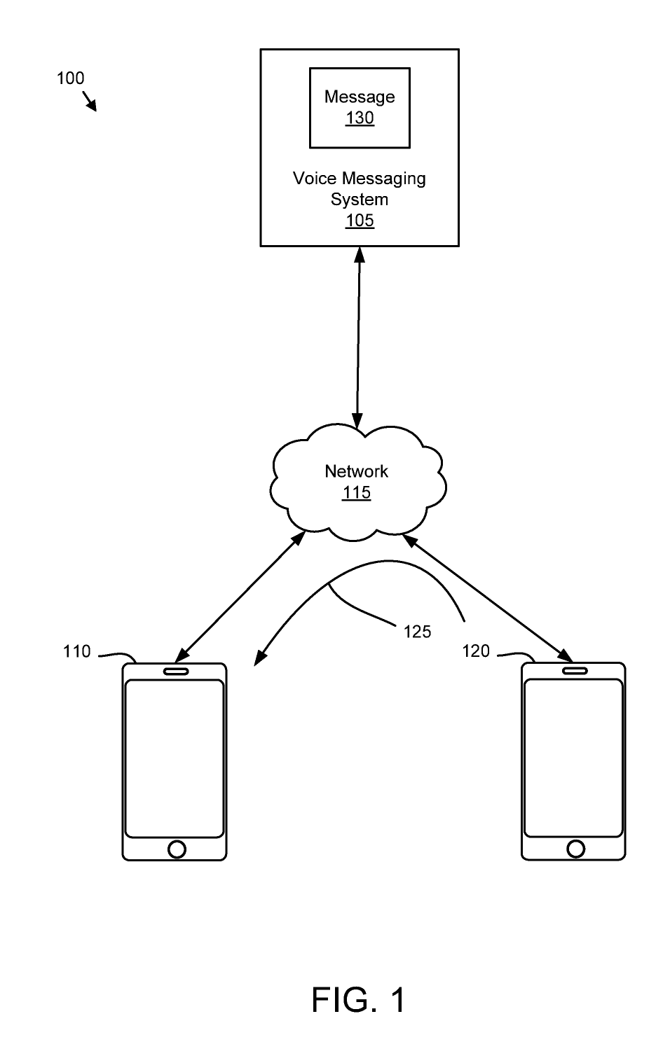

FIG. 1 is a schematic block diagram illustrating one embodiment of a return call system 100. The system 100 includes a voice messaging system 105, a calling electronic device 110, a called electronic device 120, and a network 115. The network 115 may be a mobile telephone network. Alternatively, the network 115 may be the Internet, a local area network, a wide-area network, a wireless network, a land line telephone network, one or more mobile telephone networks, or combinations thereof.

The calling electronic device 110 may place a call to a called number of the called electronic device 120 through the network 115. The called number may be a phone number. Alternatively, the called number may be an alphanumeric identifier. However, if the called electronic device 120 does not connect to the call, the calling electronic device 110 may be redirected to the voice messaging system 105. In one embodiment, the voice messaging system 105 is embodied in a server farm that is in communication with the network 115. Alternatively, the voice messaging system 105 may be embodied in the called electronic device 120. The voice messaging system 105 may record a message 130 from the calling electronic device 110.

While the calling electronic device 110 is in communication with the voice messaging system 105, the called electronic device 120 may place a return call 125 to the calling electronic device 110. Unfortunately, because the calling electronic device 110 is communication with the voice messaging system 105, the user of the calling electronic device 110 may miss the return call 125. Alternatively, even if the calling electronic device 110 accepts the return call 125, there may still be an unnecessary message 130 left in the voice messaging system 105 for the called electronic device 120 that must later be deleted from the voice messaging system 105.

The embodiments described herein identify the return call 125 from the called number of the called electronic device 120 during communication with the voice messaging system 105 associated with the called number. In addition, the embodiments may connect to the return call 125 as will be described hereafter.

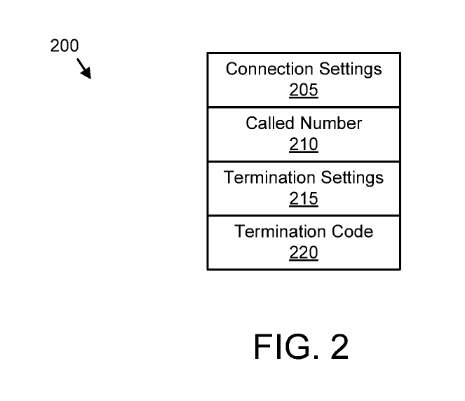

FIG. 2 is a schematic block diagram illustrating one embodiment of electronic device data 200. The electronic device data 200 may be stored on the calling electronic device 110. In one embodiment, the electronic device data 200 is stored in a data structure. The electronic device data 200 may include connection settings 205, the called number 210, termination settings 215, and a termination code 220.

The connection settings 205 may specify when to connect to return call 125. In one embodiment, the connection settings 205 mandate connecting to all return calls 125. Alternatively, the connection settings 205 may mandate connecting to return calls 125 from one or more specified return call numbers and/or identifiers that are included in the connection settings 205. In a certain embodiment, the connection settings 205 include one or more do-not-connect electronic device numbers and/or identifiers. If the return call 125 is from a do-not-connect electronic device numbers and/or identifiers, the connection settings 205 may mandate that the calling electronic device 110 ignore the return call 125.

The called number 210 is the number of the called electronic device 120. The called number 210 may be stored when the call is placed to the called electronic device 120. In addition, the called number 210 may be erased when the calling electronic device 110 connects to the called electronic device 120. Alternatively, the called number 210 may be erased when the calling electronic device 110 terminates communication with the voice messaging system 105.

The termination settings 215 may specify how to terminate communications with the voice messaging system 105. In one embodiment, the termination settings 215 mandate erasing a message 130 from the calling electronic device 110 to the voice messaging system 105 for the called number 210. Alternatively, the termination settings 215 may mandate providing in an erase option to a user of the calling electronic device 110. In addition, the termination settings 215 may mandate receiving an erase confirmation before erasing the message 130 from the calling electronic device 110 to the voice messaging system 105.

Alternatively, the termination settings 215 may mandate that the message 130 is not erased. In one embodiment, the termination settings 215 specify one or more erase electronic device numbers and/or identifiers. The termination settings 215 may mandate erasing messages 130 for calls placed to the erase electronic device numbers and/or identifiers. In addition, the termination settings may specify one or more do-not-erase electronic device numbers and/or identifiers. The termination settings 215 may mandate not erasing messages 130 placed to the do-not-erase electronic device numbers and/or identifiers.

The termination code 220 may store one or more codes that are communicated to the voice messaging system 105 to terminate communication with the voice messaging system 105 and/or to erase the message 130 from the calling electronic device 110 to the voice messaging system 105 for the called number 210. For example, the termination code 220 may be a “*3” telephonic code that erases the message 130.

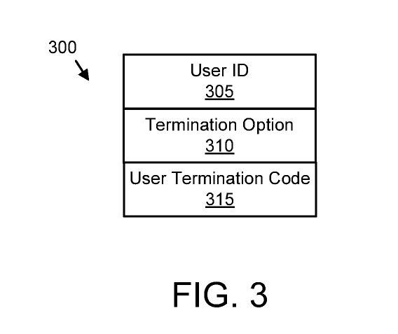

FIG. 3 is a schematic block diagram illustrating one embodiment of voice messaging system data 300. The voice messaging system data 300 may be stored in the voice messaging system 105. The voice messaging system data 300 may be organized as a data structure. In one embodiment, the voice messaging system data 300 may be organized as an entry in a database, with an entry for each user of the voice messaging system 105. In the depicted embodiment, the voice messaging system data 300 includes a user identifier 305, a termination option 310, and a user termination code 315.

The user identifier 305 may be the electronic device numbers and/or identifiers of the called electronic device 120. The termination option 310 may determine what is done with a message 130 from the calling electronic device 110 to the voice messaging system 105 for the called number 210 in response to receiving a termination code 220.

In one embodiment, if the termination code 220 is received, the termination option 310 may mandate that the message 130 is erased. Alternatively, if the termination code 220 is received the termination option 310 may mandate that the message 130 is not erased.

The user termination code 315 may be specified by the user of the called electronic device 120. In one embodiment, the voice messaging system 105 may erase the message 130 from the calling electronic device 110 to the voice messaging system 105 for the called number 210 only in response to receiving the user termination code 315. Thus the calling electronic device 110 must possess the user termination code 315 in order to erase the message 130 at the voice messaging system 105.

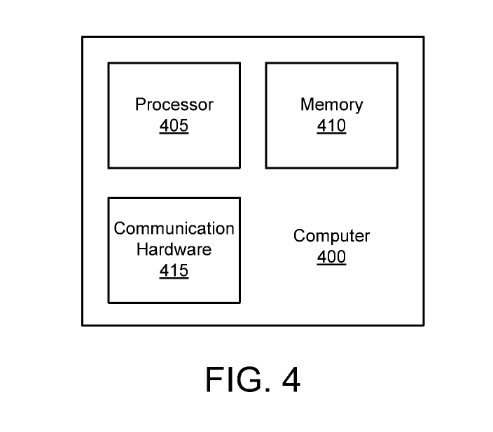

FIG. 4 is a schematic block diagram illustrating one embodiment of a computer 400. The computer 400 may be the calling electronic device 110, the called electronic device 120, and/or the voice messaging system 105. The computer 400 includes a processor 405, a memory 410, and communication hardware 415. The memory 410 may be a semiconductor storage device, a hard disk drive, an optical storage device, a micromechanical storage device, or the like. The memory 410 may store code. The processor 405 may execute the code. The communication hardware 415 may communicate with other devices. For example, the communication hardware 415 of the calling electronic device 110, the called electronic device 120, and/or the voice messaging system 105 may communicate with the network 115.

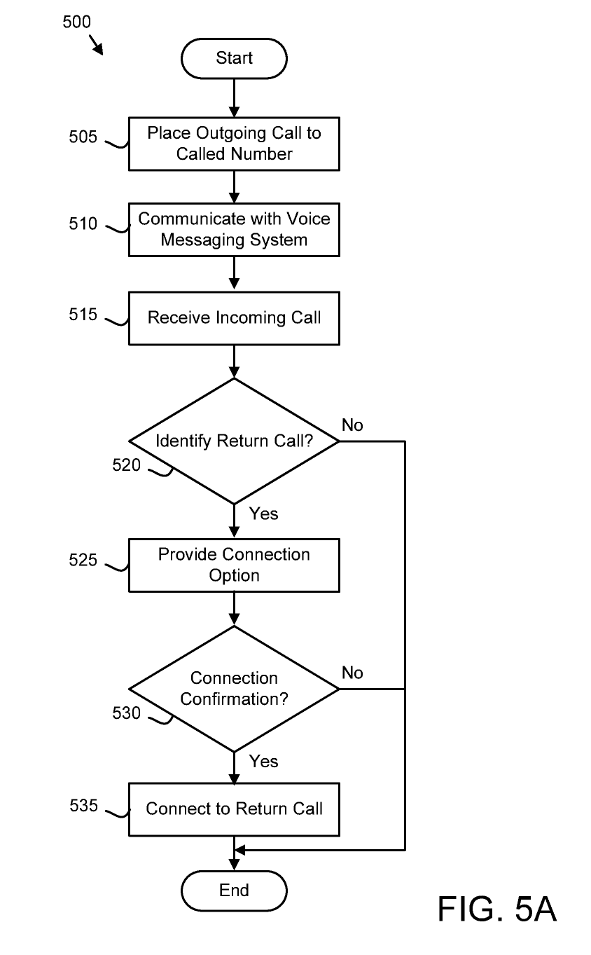

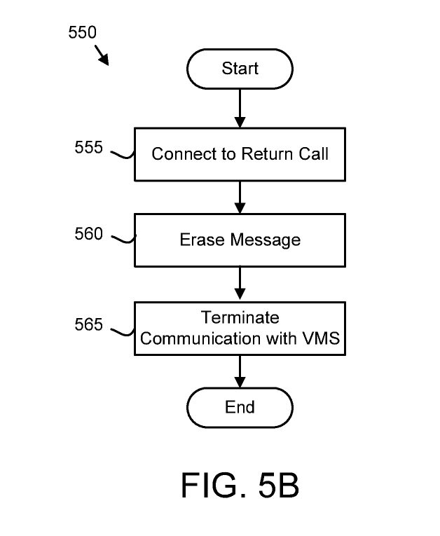

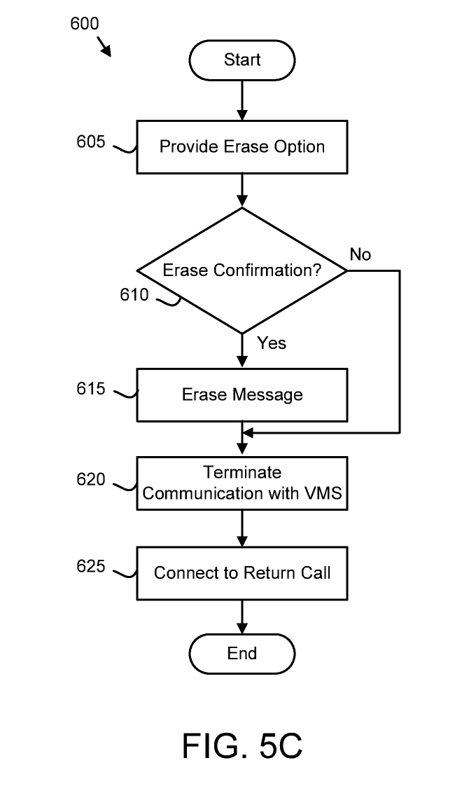

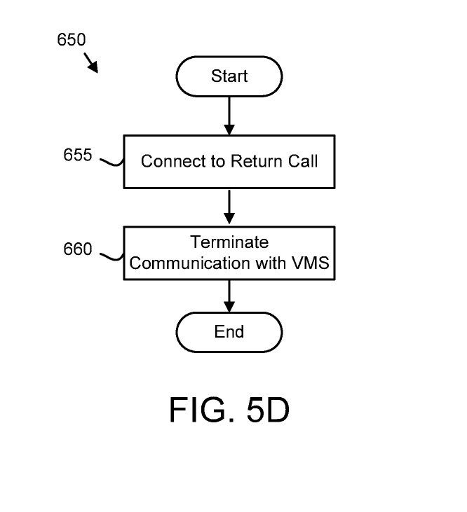

FIG. 5A is a schematic flow chart diagram illustrating one embodiment of a return call connection method 500. The method 500 may connect to the return call 125. The method 500 may be performed by the processor 405 executing code. Alternatively, the method 500 may be performed by a program product comprising a computer readable storage medium such as the memory 310. The computer readable storage medium may store the code that is executed by the processor 405 to perform the functions of the method 500.

The method 500 starts, and in one embodiment, the calling electronic device 110 places 505 an outgoing call to a called number associated with the called electronic device 120. In one embodiment, the calling electronic device stores the called number 210. In response to the outgoing call, the calling electronic device 110 may communicate 510 with the voice messaging system 105. For example, if the called electronic device 120 does not accept the outgoing call, the calling electronic device 110 may be placed in communication 510 with the voice messaging system 105.

The calling electronic device 110 may receive 515 an incoming call during communication with the voice messaging system 105 associated with the called number 210. The calling electronic device 110 may determine 520 if the incoming call is a return call 125. In one embodiment, the incoming call is the return call 125 if the incoming call is from the called number 210.

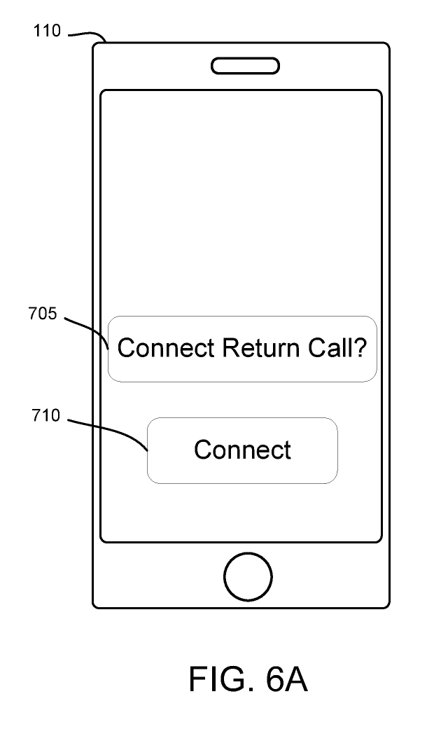

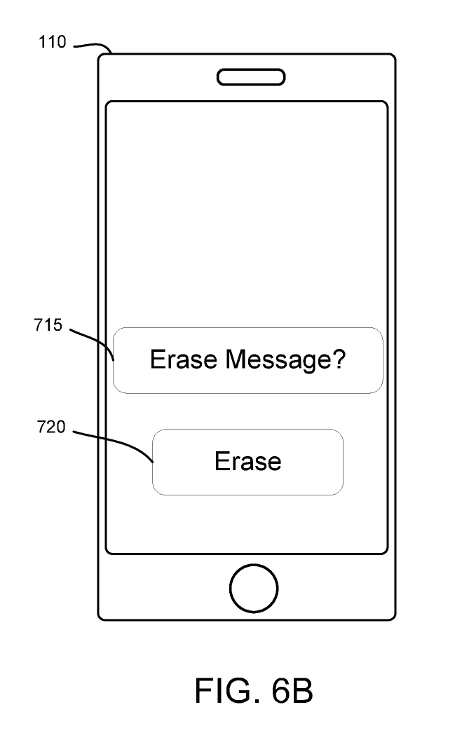

If the incoming call is not a return call 125, the method 500 ends. If the incoming call is a return call 125, the calling electronic device 110 may provide a connection option. The connection option may be one or more of an audio notification and display notification on the calling electronic device 110. For example, the display of the calling electronic device 110 may display “connect return call?” FIG. 6A illustrates a connection option.

The calling electronic device 110 may further determine 530 if a connection confirmation is received. The connection confirmation may be one or more of a verbal command, a touch screen command, and a confirmation button signal. For example, the connection confirmation may be the verbal command “connect.” Alternatively, the confirmation command may be a touch to a displayed button on a touch screen to generate the touch screen command. In addition, depressing a dedicated confirmation button may generate the confirmation button signal connection confirmation. In one embodiment, if the calling electronic device 110 does not receive the connection confirmation, the method 500 ends. FIG. 6A illustrates a connection confirmation.

If the calling electronic device 110 receives the connection confirmation, the calling electronic device 110 may connect 535 to the return call 125 and the method 500 ends. In one embodiment, the calling electronic device 110 may allow the user to communicate through the calling electronic device 110 to the called electronic device 120. In addition, the calling electronic device 110 may terminate communication with the voice messaging system 105 in response to connecting 535 to the return call 125 as described hereafter in FIGS. 5B-D.

FIG. 5B is a schematic flow chart diagram illustrating one embodiment of a voice messaging system termination method 550. The method 550 may connect to return call 125 and terminate communication with the voice messaging system 105. The method 550 may be performed by the processor 405 executing code. Alternatively, the method 550 may be performed by a program product comprising a computer readable storage medium such as the memory 310. The computer readable storage medium may store the code that is executed by the processor 405 to perform the functions of the method 550.

The method 550 starts, and in one embodiment, the calling electronic device 110 connects 555 to the return call 125, allowing the user of the calling electronic device 110 to communicate with the user of the called electronic device 120 as described in step 535 of FIG. 5A. In addition, the calling electronic device 110 may erase 560 a message 130 communicated to the voice messaging system 105 by the calling electronic device 110. In one embodiment, the calling electronic device 110 communicates the termination code 220 to the voice messaging system 105 to erase 560 the message 130.

In an alternative embodiment, the calling electronic device 110 communicates the user termination code 315 to the voice messaging system 105. The user termination code 315 may have been communicated to the calling electronic device 110 and stored as a termination code 220.

In response to receiving the termination code 220, the voice messaging system 105 may erase 560 the message 130. In one embodiment, when the called electronic device 120 communicates with the voice messaging system 105, the message 130 will be unavailable for retrieval. Alternatively, the message 130 may only be retrievable using a specified retrieval option.

The calling electronic device 110 may further terminate 565 communications with the voice messaging system 105 and the method 550 ends. In one embodiment, the calling electronic device 110 terminates 565 communications by hanging up. Alternatively, the calling electronic device 110 may cause the voice messaging system 105 to terminate 565 the communication by communicating the termination code 220 and a voice messaging system 105 may hang up when the message 130 is scheduled for erasure.

FIG. 5C is a schematic flow chart diagram illustrating one alternate embodiment of a voice messaging system termination method 600. The method 600 may connect to the return call 125 as described in step 535 of FIG. 5A, and terminate communication with the voice messaging system 105. The method 600 may be performed by the processor 405 executing code. Alternatively, the method 600 may be performed by a program product comprising a computer readable storage medium such as the memory 310. The computer readable storage medium may store the code that is executed by the processor 405 to perform the functions of the method 600.

The method 600 starts, and in one embodiment, the calling electronic device 110 provides 605 an erase option to a user of the calling electronic device 110. The erase option may be a display notification. Alternatively, the erase option may be an audio notification. One embodiment of the erase option is illustrated in FIG. 6B.

The calling electronic device 110 may determine 610 if an erase confirmation is received. The erase confirmation may be one or more of the verbal command and a touch screen command. If the erase confirmation is not received, the calling electronic device 110 may terminate 620 communications with the voice messaging system 105. One embodiment of the erase confirmation is illustrated in FIG. 6B.

If erase confirmation is received, the calling electronic device 110 may erase 615 the message 130 from the calling electronic device 110 of the voice messaging system 115. In one embodiment, when the called electronic device 120 communicates with the voice messaging system 105, the message 130 will be unavailable for retrieval. Alternatively, the message 130 may only be retrieved using a specified retrieval option.

The calling electronic device 110 may further terminate 620 communication with the voice messaging system 105 is described for step 565 of FIG. 5B. In addition, the calling electronic device 110 may connect 625 to the return call 125 and the method 600 ends. Connecting 625 to the return call 125 may allow the user of the calling electronic device 110 to communicate with the user of the called electronic device 120.

FIG. 5D is a schematic flow chart diagram illustrating one alternate embodiment of a voice messaging system termination method 650. The method 650 may connect to the return call 125 as described in step 535 of FIG. 5A and terminate communications with the voice messaging system 105. The method 650 may be performed by the processor 405 executing code. Alternatively, the method 650 may be performed by a program product comprising a computer readable storage medium such as the memory 310. The computer readable storage medium may store the code that is executed by the processor 405 to perform the functions of the method 650.

The method 650 starts, and in one embodiment, the calling electronic device 110 connects 655 to the return call 125. Connecting 655 to the return call 125 may allow the user of the calling electronic device 110 to communicate with the user of the called electronic device 120. In addition, the calling electronic device 110 may terminate 660 communications with the voice messaging system 105 and the method 650 ends.

FIG. 6A is a drawing illustrating one embodiment of a connection option 705 and a connection confirmation 710 on the calling electronic device 110. In the depicted embodiment, the connection option 705 is a display notification asking the user if the user wishes to connect the return call 125. The user may issue a connection confirmation 710 by pressing the button associated with the connection confirmation 710.

FIG. 6B is a drawing illustrating one embodiment of an erase option 715 and an erase confirmation 720 on the calling electronic device 110. In the depicted embodiment, the erase option 715 is a display notification asking the user if the user wishes to erase the message 130 from the calling electronic device 110 on the voice messaging system 105. The user may issue an erase confirmation 720 by pressing the button associated with the erase confirmation 720.

The embodiments identify at a calling electronic device 110 a return call 125 from a called number during communication with the voice messaging system 105 associated with the called number. In addition, the embodiments connect the calling electronic device 110 to the return call 125. As a result, the calling electronic device 110 is able to connect with the called electronic device 110 more rapidly. A message 130 left by the calling electronic device 110 on the voice messaging system 105 may be erased so that the called electronic device 110 does not have an unnecessary message 130 on the voice messaging system 105

Embodiments may be practiced in other specific forms. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A apparatus comprising:
an electronic device comprising a processor and a memory that stores code executable by the processor, the code comprising:
code that identifies a return call from a called number during communication with a voice messaging system associated with the called number; and
code that connects to the return call.

2. The apparatus of claim 1, the code further comprising:
code that provides a connection option; and
code that connects to the return call in response to a connection confirmation.

3. The apparatus of claim 2, wherein the connection option comprises one or more of an audio notification and a display notification.

4. The apparatus of claim 2, wherein the connection confirmation comprises one or more of a verbal command, a touch screen command, and a confirmation button signal.

5. The apparatus of claim 1, the code further comprising code that terminates the communication with the voice messaging system.

6. The apparatus of claim 5, wherein terminating the communication with the voice messaging system comprises erasing a message.

7. A method comprising:
identifying, by use of a processor, a return call from a called number during communication with a voice messaging system associated with the called number; and
connecting to the return call.

8. The method of claim 7, the method further comprising:
providing a connection option; and
connecting to the return call in response to a connection confirmation.

9. The method of claim 8, wherein the connection option comprises one or more of an audio notification and a display notification.

10. The method of claim 8, wherein the connection confirmation comprises one or more of a verbal command, a touch screen command, and a confirmation button signal.

11. The method of claim 7, the method further comprising terminating the communication with the voice messaging system.

12. The method of claim 11, wherein terminating the communication with the voice messaging system comprises erasing a message.

13. The method of claim 7, wherein the message is erased in response to:
providing an erase option; and
receiving an erase confirmation.

14. A program product comprising a computer readable storage medium that stores code executable by a processor to perform:
identifying a return call from a called number during communication with
a voice messaging system associated with the called number; and
connecting to the return call.

15. The program product of claim 14, the code further performing:
providing a connection option; and
connecting to the return call in response to a connection confirmation.

16. The program product of claim 15, wherein the connection option comprises one or more of an audio notification and a display notification.

17. The program product of claim 15, wherein the connection confirmation comprises one or more of a verbal command, a touch screen command, and a confirmation button signal.

18. The program product of claim 14, the code further terminating the communication with the voice messaging system.

19. The program product of claim 18, wherein terminating the communication with the voice messaging system comprises erasing a message.

20. The program product of claim 19, wherein the message is erased in response to:
providing an erase option; and
receiving an erase confirmation.
